(19) United States
(12) Patent Application Publication
(10) Pub. No.: US 2006/0082826 A1
(43) Pub. Date: Apr. 20, 2006

(54) Intelligent photo printer

(76) Inventors: Christian Joly, Mountain View, CA (US); Doug Goodyear, Los Altos Hills, CA (US); John J. Harrison, Northborough, MA (US)

Correspondence Address: GLENN PATENT GROUP, 3475 EDISON WAY, SUITE L, MENLO PARK, CA, 94025, US

(21) Appl. No.: 11/250,502

(22) Filed: Oct. 14, 2005

Related U.S. Application Data
(60) Provisional application No. 60/619,614, filed on Oct. 18, 2004.

(51) Int. Cl. G06F 3/12

(52) U.S. Cl. 358/1.15

(57) ABSTRACT

The invention provides an intelligent photo printer that enables a user to select a desired image enhancement algorithm that is suitable for a particular printer, download the algorithm to the printer and, if necessary makes a usage payment to the algorithm provider. Algorithm enhancements include such features as, color effects, red eye removal, image enhancement, adding logos and watermarks, adding text, and adding borders.

### CROSS-REFERENCE TO RELATED APPLICATIONS

This application claims priority to U.S. provisional patent application Ser. No. 60/619,614 submitted Oct. 18, 2004, which application is incorporated herein in its entirety by this reference thereto.

### BACKGROUND OF THE INVENTION

1. Technical Field

The invention relates generally to the enhancement of printing devices. More specifically, the invention relates to the selective download of algorithms to a photographic printer for the purpose of enhancing the printer's image processing capabilities.

2. Description of the Prior Art

Recently, printers have become commonly available with practically every personal computer. The low price of ink-jet printers that provide color printing, together with the availability of high quality printing paper, have provided consistently higher quality printing. Advancements in digital photography in a variety of resolutions have also given the average user the ability to capture digital images and print them on demand at their convenience. Printers have become sophisticated and have significant processing power and memories, thus allowing them to handle the complex printing requirements of images in general, and photographic images in particular.

As shown in FIG. 1, printers, such as printer 120, may connect to a network 110 directly, or via a computer 130 (135), for example a personal computer (PC), connected to the network. Such printers can communicate with a server connected to the network for a variety of purposes described in prior art, including for example, updating of fonts, firmware, receiving print data, and the like. Some printers are also capable of receiving data through a memory slot for direct printing of images from a memory card of, for example, a digital camera. Such printers may have a small screen that allows the user to perform certain printing functions in connection with the photographs in the memory card.

In the processing of images, a multitude of algorithms is commonly used to handle various aspects of the image to be printed. These algorithms provide among others, resolution enhancement, visual effects, colour rendering and more. However, with the advancement of photo printers there is a need in the art to provide a more flexible architecture to allow for the update of image processing algorithms that allow effective preferably automatic manipulation, of an image to be printed. It would be advantageous if this need would be resolved in such a way that would allow a provider of an algorithm to charge a fee for the use, or license thereof, of an algorithm. It would also be preferable if such algorithm would have a life meter to determine the maximum use time of the algorithm.

### SUMMARY OF THE INVENTION

The invention provides an intelligent photo printer that enables a user to select a desired image enhancement algorithm that is suitable for a particular printer, download the algorithm to the printer and, if necessary makes a usage payment to the algorithm provider. Algorithm enhancements include such features as, color effects, red eye removal, image enhancement, adding logos and watermarks, adding text, and adding borders.

### BRIEF DESCRIPTION OF THE DRAWINGS

FIG. 1 is a block diagram showing an exemplary network having at least a printer and server connected thereto;

FIG. 2 is a block schematic diagram of intelligent photo printer controller having means for algorithm updates in accordance with the disclosed invention; and

FIG. 3 is an exemplary flowchart showing algorithm download and control in accordance with the disclosed invention

### DETAILED DESCRIPTION OF THE INVENTION

The presently preferred embodiment of the invention comprises a photo printer that is equipped with an intelligent photo printer controller which may be updated by any of various algorithms that provide additional imaging processing features to the printer. The algorithms may be downloaded selectively from, for example, a Web site of a provider of such algorithms and, if so required, the user can pay for a license that allows the use of such algorithm and cause the photo printer to install the algorithm for such use. In one embodiment of the disclosed invention, a user may exceed the downloaded algorithm either a predetermined number of uses or for a predetermined time interval before the usage license expires.

FIG. 1 is a block schematic diagram showing a network 110 that connects between various elements of a printing network system 100. Such networks are known in the art. A printer 120 may have direct access to network 110 thereby allowing, for example, a personal computer (PC) 130 to print over the network 110 on a network printer 120. The PC 130 may also have a local printer 135 connected to it through an internal means of connection, such as a serial bus, parallel bus, universal system bus (USB), wireless connection including but not limited to Bluetooth, WiFi, WiMax, and the like.

It is now common for photo printers to have a display and, hence, the network printer 120 may also have a display, optionally having touch screen capabilities, as well as a keyboard that allows for its independent operation. This is suitable, for example, to fit the purpose of printing photographs from a memory card inserted into one of its memory card slots. A server 140 is also shown connected to the network 110 to allow, for example, the server 140 to send a print job to the network printer 120. The server 140 may, for example, be a host of a Web site at which a plurality of image processing algorithms are available in accordance with the disclosed invention and as further detailed herein below.

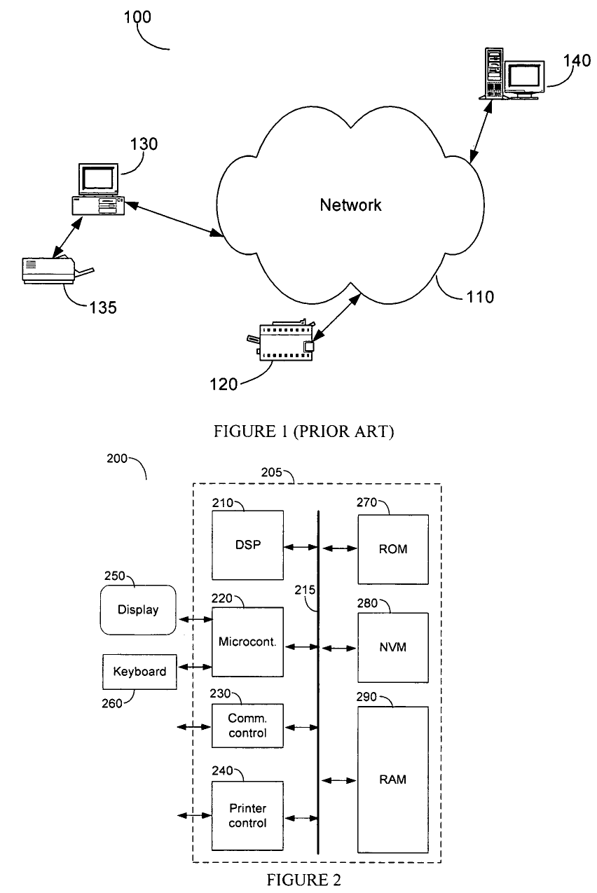

FIG. 2 shows an intelligent photo printer controller 200 comprising a digital signal processor (DSP) 210, a microcontroller 220, a communication control 230, and a print control 240, all of which are connected to a system bus 215. Also, connected to in this embodiment is a read only memory (ROM) 270, a non-volatile memory (NVM), and a random access memory (RAM) 290, typically comprised of, but not limited to, static RAM (SRAM) or double data rate (DDR) memory devices. In one embodiment of the invention, these elements are integrated as a single semiconductor device 205, but they could be comprised of several semiconductor devices. The microcontroller 220 is further, optionally, connected to a display 250 and a keyboard 260. The display 250 may, optionally, be equipped with touch screen capabilities. The DSP 210 is capable of communicating with the NVM 280 for the purpose of executing certain image processing algorithms that are stored in the NVM 280. The NVM 280 is preferably configured to allow it to be loaded with new algorithms, to allow algorithms to be removed from the NVM 280. The NVM 280 is capable of storing usage information concurring each algorithm, as discussed in more detail below.

Under supervision of the microcontroller 220 it is possible to communicate with a server, for example a server 140, to download an algorithm from the server 140, through the communication control 230, and into the NVM 280. In one embodiment of the invention, if the algorithms are intended for a single use only, the algorithm is downloaded into a RAM 290. In yet another embodiment of the invention, if the memory space available on-chip in the semiconductor device 205 is not sufficient for an algorithm, external memory devices may be added to the semiconductor device 205 to achieve the same goals. To access the server, the keyboard 260 and the display 250 may be used, under the control of the microcontroller 220, operating under built-in code, typically stored in a ROM 270. In another embodiment of the invention, access to the server is performed under the control of a PC, for example the PC 130. Once an algorithm is downloaded into the NVM 280 of the intelligent photo printer controller 200, an image may be printed using the desired image processing, including the features provided by the newly downloaded algorithm.

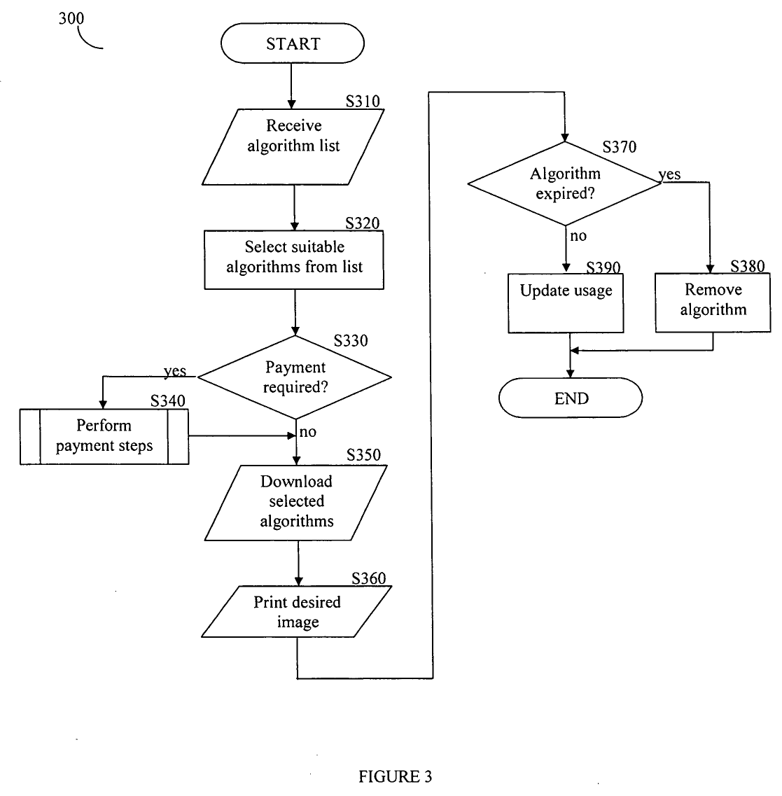

FIG. 3 is a flow diagram showing where an exemplary and non-limiting method for the download of an algorithm to the NVM 280 of the intelligent photo printer controller 200. In step S310, a list of potential algorithms is received over the network, for example the network 110, from a server, for example the server 140. In step S320, an algorithm is selected for downloading purposes. A person skilled-in-the-art would note that while the download of a single algorithm is discussed in this example, it is within the scope of the disclosed invention to download a plurality of algorithms to, for example, the NVM 280. In one embodiment of the invention, a comparison is performed between the available amount of memory in, for example, the NVM 280, and the amount of memory required by the image processing algorithm selected to be downloaded. Corrective action may be taken if there is insufficient memory space available. In step S330, a check is made to determine whether payment is required for the selected algorithm and, if so, then in step S340 a plurality of steps respective of the necessary payment are performed; otherwise, execution continues with step S350.

In accordance with the invention, a server 140 may contain a plurality of image processing algorithms for execution in conjunction with the capabilities of the DSP 210. A user uploading algorithms to the server 140 may wish to be compensated for the use of the developed algorithm and, hence, the need to include a payment charging step in the process of downloading the algorithm into an intelligent photo printer controller 200. Payment options may include a single use license, a life-time use license, a time based license, for example, use for a period of twelve months, or a quantity based license, for example, for printing twenty images using the downloaded image processing algorithm. Similar to the updating capabilities of the image processing algorithms, a person skilled-in-the-art would note that it is possible to extend this approach with regard to the licensing and/or selling of the rights to use the downloaded algorithm by updating the firmware used by the microcontroller 220.

In FIG. 3, in step S350 the selected algorithm is downloaded into a memory, for example, the NVM 280, into an available memory slot. In one embodiment of the invention, this ends the execution of the method and the method can be repeated as desired. In another embodiment of the invention, execution continues with steps S360 through S390, and in yet another embodiment, these steps are a separate algorithm executed when necessary. In step S360, a desired printout is printed, for example a photograph, using the downloaded algorithm. In step S370, a check is performed to determine whether the algorithm usage permit has expired and, if so, execution continues with step S380; otherwise, execution continues with step S390, where the usage information concerning the algorithm is updated. In step S380 the algorithm for which a usage permit has expired is removed from, for example, the NVM 280, thereby preventing additional use of the algorithm. In another embodiment, the algorithm is not actually removed from memory but is disabled from further use and, hence, is deemed unavailable to a user of the intelligent photo printer.

In accordance with the disclosed invention there are also provided a compiler and an emulator for the use of those who develop the image processing algorithms discussed above. The developer develops the code in a computer language, for example C, and compiles the result into a low-level code suitable for running on the DSP of the disclosed system. The code is then emulated using the emulator that is capable of emulating the execution of the native code of the DSP, and a result as provided. If the result is satisfactory, such code can be made available to a user in the ways discussed above for the purpose of download for use on a local or networked printer.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

1. A photo printer, comprising:
a photo quality print head for printing photo quality printed images at photo resolution;
means for downloading an image processing algorithm to said photo print; and
an intelligent photo printer controller for controlling said photo quality print head and for processing an image to be printed by said photo quality print head, in accordance with said image processing algorithm.

2. The photo printer of claim 1, said intelligent photo printer controller further comprising:
a digital signal processor (DSP) for processing any of a plurality of image processing algorithms;
first communication means for receiving an image processing algorithm; and
a second communication means for receiving a print image;
computing means for receiving commands for adding said image processing algorithm to said photo printer,
a first memory for storing said image processing algorithm; and
a second memory for storing said print image.

3. The photo printer of claim 2, said first communication means and said second communication means comprising a single means of communication.

4. The photo printer of claim 2, wherein said first memory and said second memory comprising a single memory.

5. The photo printer of claim 2, said first memory comprising a non-volatile memory (NVM).

6. The photo printer of claim 2, said commands for an image processing algorithm further comprising commands for enabling a purchase transaction in connection with said at least a new image processing algorithm.

7. The photo printer of claim 6, said purchase transaction enabling any of a single use of said image processing algorithm, a time-limited use of said image processing algorithm, and a perpetual use of said at least a new image processing algorithm.

8. The photo printer of claim 2, said intelligent photo printer controller further comprising display means.

9. The photo printer of claim 8, said display means comprising a touch sensitive screen.

10. The photo printer of claim 1, said algorithm providing functionality for any of: color effects, red eye removal, image enhancement, adding logo and/or watermarks, adding text, and adding borders.

11. An intelligent photo printer controller comprising:
a digital signal processor (DSP) for processing any of a plurality of image processing algorithms;
first communication means for receiving an image processing algorithm; and
a second communication means for receiving a print image;
computing means for receiving commands for adding said image processing algorithm to said photo printer;
a first memory for storing said image processing algorithm; and
a second memory for storing said print image.

12. The intelligent photo printer controller of claim 11, said first communication means and said second communication means comprising a single means of communication.

13. The intelligent photo printer controller of claim 11, said first memory and said second memory comprising a single memory.

14. The intelligent photo printer controller of claim 11, said first memory comprising a non-volatile memory (NVM).

15. The intelligent photo printer controller of claim 11, said commands for adding an image processing algorithm further comprising commands for enabling a purchase transaction of said image processing algorithm.

16. The intelligent photo printer controller of claim 15, said purchase transaction enabling any of a single use of said new image processing algorithm, a multiple-use of said new image processing algorithm, a time-limited use of said new image processing algorithm, and a perpetual use of said new image processing algorithm.

17. The intelligent photo printer controller of claim 10, said intelligent photo printer controller further comprising:
display means.

18. The intelligent photo printer controller of claim 11, said display means further comprising a touch sensitive screen proximate to said display.

19. The intelligent photo printer of claim 11, said algorithm providing functionality for: any of color effects, red eye removal, image enhancement, adding logo and/or watermarks, adding text, and adding borders.

20. A method for downloading an image processing algorithm to a memory of an intelligent photo printer controller, comprising the steps of:
receiving a list of available image processing algorithms;
selecting a suitable image processing algorithm from said list;
checking if payment is required for such a selected image processing algorithm and, if so, executing the steps required for payment; and
downloading the selected algorithm.

21. The method of claim 20 further comprising the step of:
displaying said list of available image processing algorithms.

22. The method of claim 21, said step of selecting a suitable algorithm comprising the step of:
identifying a selection from a touch sensitive screen proximate to said display.

23. The method of claim 20, wherein said payment is for any of:
a single use of said selected image processing algorithm, a multiple-use of said selected image processing algorithm, a time-limited use of said selected image processing algorithm, and a perpetual use of said selected image processing algorithm.

24. The method of claim 23, further comprising the steps of:
printing a desired image using said downloaded algorithm; and
checking usage information of said downloaded image processing algorithm to determine if a maximum permitted usage is met and, if so, preventing further use of said downloaded algorithm; otherwise, updating said usage information for said downloaded algorithm.

25. The method of claim 20, wherein said image processing algorithm is executed on a digital signal processor (DSP) of an intelligent photo printer controller.

26. The method of claim 20, said algorithm providing functionality for any of color effects, red eye removal, image enhancement, adding logo and/or watermarks, adding text, and adding borders.

27. A photo printer comprising an intelligent photo printer controller, the intelligent printer controller configured to be operative in accordance with the method of claim 20.

28. An intelligent photo printer controller configured to be operative in accordance with the method of claim 20.
